(19) United States
(12) Patent Application Publication
(10) Pub. No.: US 2012/0037005 A1
(43) Pub. Date: Feb. 16, 2012

(54) FILTER INTEGRITY MONITORING SYSTEM

(75) Inventors: Etienne René Jarrier, Basingstoke (GB); John Carl Davies, Portsmouth Hampshire (GB)

(73) Assignee: General Electric Company, Schenectady, NY (US)

(21) Appl. No.: 12/855,814

(22) Filed: Aug. 13, 2010

(51) Int. Cl. B01D 35/143

(52) U.S. Cl. 96/414; 96/417

(57) ABSTRACT

A system for fluid filtration and for providing an indication of filtration operation. The system uses a filtration media for permitting flow of fluid there through and for filtering at least one material from the fluid. The filtration media has an upstream side and a downstream side. The system includes a member located adjacent to the downstream side of the filtration media and permitting flow of the fluid there through. The member retains at least some of the at least one material not filtered from the fluid by the filtration media. The member is contrast to the at least one material so that an indication of locality of reduced filtration of the at least one material is provided.

### BACKGROUND OF THE INVENTION

1. Field of the Invention

The invention relates generally to a filtration system, and more particularly, to a filtration system that can provide an indication of a filtration media defect.

2. Discussion of Prior Art

Filter elements may be used to provide clean fluid, such as air, to or from various devices. Such devices may include gas turbines. Filter elements contain filtration media, and the filter elements are in various forms such as panels or other configurations. Also, the filter elements are planar or contoured, such as pleated or the like. The filter elements are used singularly and are also used as part of arrays, such as within filter houses. The particular characteristics, composition, etc. of the filtration media within the filter elements are varied to correspond to the type of filtering to be performed, the particulate matter being filtered, etc.

In order for a filter element within a filter element to provide a desired filtering effect, the filtration media needs to be in serviceable condition. One condition that may result in filtration media not being in serviceable condition is a media defect, such as a hole, a tear, a seal defect, or the like. Such a defect would permit unwanted particulate matter passing the filtration media at the location of the defect.

It is possible to try to determine whether the filtration media within a filter element has a defect. A rudimentary approach is to attempt to locate defects via visual inspection. However, such an approach may require interruption of operation of the filtering and/or the device (i.e., a turbine) associated with the filtering. Also, such an approach may require that the filter element be removed for inspection or otherwise accessed by the person conducting the inspection. Such a rudimentary approach of course has some disadvantages, including man-power needs and operation down-time.

There are also more sophisticated systems/methods that have been used to try to determine whether the filtration media within a filter element has a defect. For example, WO2007GB0003325 discloses a system that monitors the filtration media integrity by using downstream and upstream probes and by counting particulate matter. As another example, EP1760292A2 discloses a system that monitors the particulate count across a downstream duct. A variation of particle concentration indicates a filtration media defect failure. As a third example, JP2006009591A2 discloses a system that compares an upstream pressure versus a downstream pressure to determine a differential.

The previous sophisticated systems/methods mentioned above, may have issues related to the sophistication present therein, such as sensor equipment costs, calibration, and the like. Also, it may be difficult to for such sophisticated systems/methods to provide an indication of the location of a defect within the filtration media. Such an issue would logically become more apparent upon increases in the size of a filter element and/or the number of filter elements.

In general, there are benefits for continual improvements in filter monitoring technologies so as to address these and other issues. Specifically, there are benefits to seeking an approach that provide a cost-effective indication of a filtration media defect and which can also provide an indication of the location of the defect.

Also, the system within which a filter element is utilized may induce a pattern of fluid flow such that flow through a filter element is significantly unbalanced. For example, a significant amount of flow may pass though only one portion (e.g., one-half) of the filter. In general, this can be conceded to be aerodynamic issues. The filter element itself may be defect-free. However, it could be considered that such a scenario does not effectively and efficiently utilize the filter element. Such a scenario may result in a filter element may be replaced at a time different (e.g., shorter or longer) that the normal recommended replacement time interval.

There are benefits for identifying aerodynamic issues at a filter element. For example, adjustments could be made to more effectively and efficiently utilize the filter element.

### BRIEF DESCRIPTION OF THE INVENTION

The following summary presents a simplified summary in order to provide a basic understanding of some aspects discussed herein. This summary is not an extensive overview of the invention discussed herein. It is not intended to identify key/critical elements or to delineate the scope of such invention. Its sole purpose is to present some concepts in a simplified form as a prelude to the more detailed description that is presented later.

In accordance with one aspect, the present invention provides a system for fluid filtration and for providing an indication of filtration operation. The system includes a filtration media for permitting flow of fluid there through and for filtering at least one material from the fluid. The filtration media has an upstream side and a downstream side. The system includes a member located adjacent to the downstream side of the filtration media and permitting flow of the fluid there through. The member retains at least some of the at least one material not filtered from the fluid by the filtration media. The member is contrast to the at least one material so that an indication of locality of reduced filtration of the at least one material is provided.

In accordance with another aspect, the present invention provides a system for fluid filtration and for providing an indication of filtration operation. The system uses a filtration media for permitting flow of fluid there through and for filtering at least one material from the fluid. The filtration media has an upstream side and a downstream side. The system includes a member located adjacent to the downstream side of the filtration media and permitting flow of the fluid there through. The member retains at least some of the at least one material not filtered from the fluid by the filtration media. The member is contrast to the at least one material so that an indication of locality of reduced filtration of the at least one material is provided.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematic illustration of an example fluid filtration system that includes an aspect in accordance with the present invention;

FIG. 2 is schematized perspective view of a portion of the system shown in FIG. 1 and includes a fresh, example filter element and a fresh, example indicator member located adjacent to the filter element;

FIG. 3 is a view similar to FIG. 2, but shows a typical time-progressed contrast accumulation upon the indicator member after an amount of typical filtration has occurred at the filter element;

FIG. 4 is a view similar to FIG. 2, but shows that the filter element has a defect and shows a contrast indication upon the indicator member; and

FIG. 5 is a view similar to FIG. 2, but the filter is subjected to an aerodynamic issue such that most fluid flows through a lower portion of the filter element and a contrast indication is located as a lower portion of the indication member.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

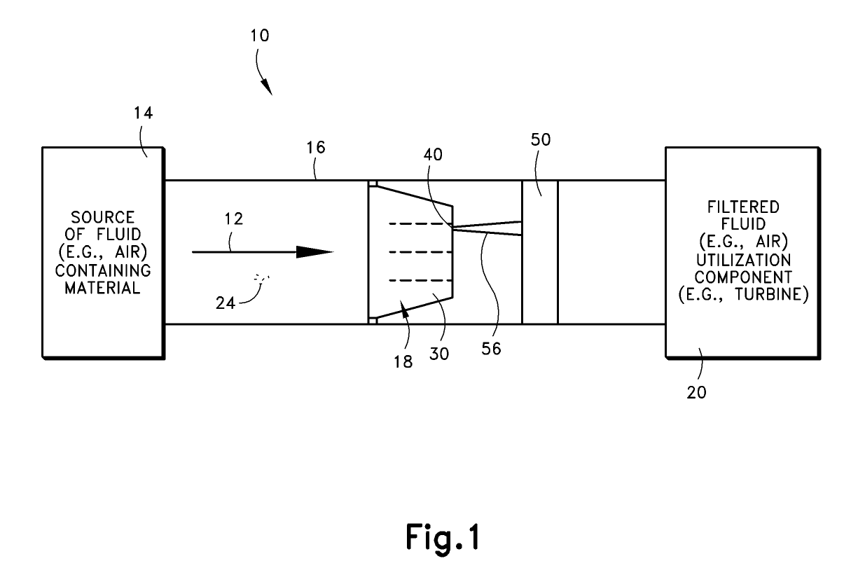

FIG. 1 schematically illustrates an example of a system 10 for fluid filtration and for providing and indication of filtration operation. The system 10 may be part of an overall larger arrangement, such as a gas turbine compressor. The specific overall arrangement within which the system is incorporated need not be a specific limitation upon the present invention.

In general, a flow of fluid 12 (generically represented by the arrowhead) proceeds from a source 14 of fluid, along a path defined by surrounding conveyance structure 16, is directed through a filter element 18, and proceeds to a filtered fluid utilization component 20. Logically, the filter element 18 has an upstream side and a down stream side.

The fluid may be air. However, other fluids (e.g., other gases besides air) may be filtered and the specific fluid being filtered may not be a specific limitation upon the invention. The fluid proceeding from the source 14 of fluid contains material 24 (only some generic material shown) that is to be filtered from the fluid via the filter element 18. The material 24 to be filtered may be particulate matter (e.g., dust). Also the source 14 of fluid may be varied. Specifically, the source 14 of fluid may be the ambient atmosphere, and thus the material 24 to be filtered from the fluid may be material that is airborne within atmospheric air. As another example, the source 14 of fluid may be a component that produces the fluid-borne material 24 (e.g., ash), with the fluid-borne material (e.g., ash) to be removed from the fluid. As such, the source 14 of fluid is to be broadly interpreted. It to be appreciated that the filtered fluid utilization component 20 may be varied. One example of the filtered fluid utilization component 20 is a turbine. Also the filtered fluid utilization component 20 may be another device (e.g., an engine) that utilizes a filtered fluid. Still further, the filtered fluid utilization component 20 may even be as basic as a clean air return to ambient atmosphere. As such, the filtered fluid utilization component 20 should be broadly interpreted.

The schematic drawing of FIG. 1 shows the components arranged at/with the conveyance structure in relatively close proximity, in a straight/linear arrangement, and in a left to right sequence. However, the example system 10 shown in FIG. 1 is merely a schematic representation of an aspect of the invention and is not a specific limitation upon the present invention. Certainly it is to be appreciated that variations in dimensions, orientations, etc. are within the scope of the invention.

The filter element 18 includes a filtration media 30 that filters the material 24 (e.g., particulate matter) from the fluid. The filtration media 30 permits flow of fluid there through and filters at least one material 24 from the fluid. The filtration media 30 has an upstream side and a downstream side, with the material 24 tending to accumulate upon the upstream side during the filtering process.

Logically, the filtration media 30 is matched to the material 24 to be filtered. As such, the filtration media 30 has particular characteristics, composition, etc. that correspond to the type of filtering to be performed, the material 24 being filtered, etc., and such characteristics, composition, etc. may not be limitations upon the present invention. The filter element 18 may be provided in a variety of forms, such as a panel or other configurations. Also, the filter element 18 may be planar or contoured, such as pleated, shaped (e.g., bag) or the like. The filter element 18 may be used singularly or may also used as part of an array, such as within a filter house. So it is to be appreciated that the specific material to be filtered, the specifics of the filter element(s), and the specifics of the filtration media of the filter element(s) need not be specific limitations upon the present invention.

In order for the filtration media 30 within a filter element 18 to provide a desired filtering effect, the filtration media needs to be in serviceable condition. One condition that may result in filtration media not being in serviceable condition is a media defect 40 (an example defect is shown in FIG. 1), such as a hole, a tear, a seal defect, or the like. Such a defect 40 would permit unwanted material 24 (e.g., particulate matter) to pass the filtration media 30 at the location of the defect. As such, the defect 40 is an example of a locality of reduced filtration of the at least one material 24.

Also, in order for the filter element 18 to provide the filtering function with good efficiency and/or with good life-cycle, the overall area of the filtration media 30 should be effectively utilized. One example of effective utilization of the filtration media 30 occurs when filtered material accumulates over the entire overall area of the filtration media in a generally uniform distribution.

In accordance with an aspect of the present invention, an indicator member 50 (highly schematized in FIG. 1) is located adjacent to a downstream side of the filtration media 30 of the filter element 18 and permitting flow of the fluid there through. The indicator member 50 retains at least some of the at least one material 24 not filtered from the fluid by the filtration media 30. The indicator member 50 has a contrast to the at least one material 24 so that visual indication of locality of reduced filtration of the at least one material is provided. It should be appreciated that distance from the downstream side of the filtration media 30 to the indicator member 50 may be varied.

The indicator member 50 may have a variety of configurations. For example, the indicator member 50 may have a peripheral frame, with a mesh or grid that extends across the flow path of the fluid proceeding from the fluid. The indicator member 50 may itself provide some level of filtering function since it is intended that at least some of the material 24 that is within the fluid is to be retained upon the member. However, the function in accordance with an aspect of the present invention is that at least some material 24 that passes the filtration media 30 of the filter element 18 is retained on the member at a location on the member that generally corresponds to a location on the filtration media through which the material passed. As such, if a relatively large amount of material 24 is passing through the filtration media 30 at a specific location, a correspondingly large amount of the material 24 will be retained upon the indicator member 50 at the corresponding location on the indicator member 50.

Turing to the aspect of the indicator member 50 having a contrast as compared to the material 24 being filtered, a variety of contract aspects could be present/utilized. For example, if the material 24 being filtered is dark, the indicator member 50 (e.g., the mesh or strands) is light. As another example, if the material 24 being filtered is light, the indicator member 50 (e.g., the mesh or strands) is dark. These are examples of contrast of shade. As another example, if the material 24 being filtered is one color, the indicator member 50 is a different, contrasting color. Still further examples, contrast may be in other manners, such as florescence vs. non-florescence, infrared vs. non-infrared (e.g., spectral), and the like. It is to be appreciated that other types of contrast are possible and are within the scope of the present invention such that the listed types of contrast need not be specific limitations upon the present invention.

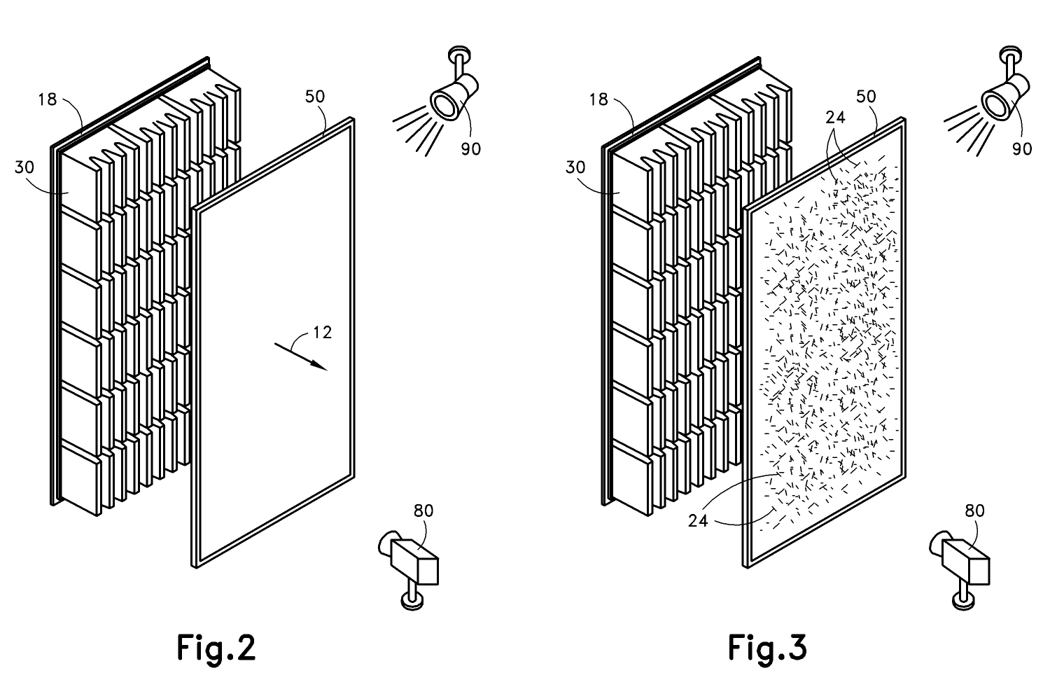

Turning to FIG. 2, an example of the filter element 18 and the indicator member 50 is shown. It is to be appreciated that the filter element 18 is shown with contouring (e.g., pleats). Also, the filter element 18 is shown as a plurality (e.g., bank) of discrete filters. In this example, the indicator member 50 is a light colored member and the material 24 (e.g., particulate) being filtered is dark. In FIG. 2, the indicator member 50 is fresh in that no material 24 has proceeded past the filter element 18 and been retained upon the indicator member 50. The arrowhead 12 generically represents the flow of the fluid through the filter element 18 and the indicator member 50.

FIG. 3 shows a time-progressed situation for the circumstance of a typical filter element operation. During the operation, some material 24 will proceed past the filter element 18. At least some material 24 is retained upon the indicator member 50. The retained material 24 is a contrast (e.g., dark upon light), so that the retained material can be perceived (e.g., seen). The retained material 24 is generically represented by the random flecks upon the indicator member 50. The size of the flecks is enlarged for illustrative purpose. It should be appreciated that the shown size, orientation, etc. of the material 24 are not limitations upon the present invention. Also, it is to be appreciated that the material 24 is retained (e.g., impinged upon) the side of the indicator member 50 facing the filter element 18, which can be considered to be an upstream side. The retained material 24 may be observed from the upstream side or the down stream side if the indicator member 50 is sufficiently transparent/translucent. In view of the fact that the operation is typical in FIG. 3, fluid flow, and thus passed material 24, is uniformly distributed. Specifically, the material 24 is uniformly distributed within the flow and thus uniformly distributed upon the indicator member 50. This uniform distribution upon the indicator member 50 is an indication of uniform distribution upon the filter element 18.

Focusing again upon FIG. 1, an example of defect (e.g., a hole) 40 is provided in the filtration media 30 and also an example trajectory cone of travel 56 for material (e.g., particulate matter) 24 proceeding through the defect 40 in the filtration media 30 is provided. It is to be appreciated that an amount of material 24 passing the filter element 18 at the defect 40 will be greater than amounts of material 24 passing the filter element 18 at other, non-defect areas. It should be appreciated that the trajectory cone of travel 56 for material 24 proceeding through the defect 40 in the filtration media 30 will result in a greater amount of material 24 impinging upon and thus being retained upon the indicator member 50 at a location. Herein, the location of greater retention can be referred to as a spot of material 24 (e.g., a material spot). If the material 24 is dust, the material spot can be considered to be a dust spot.

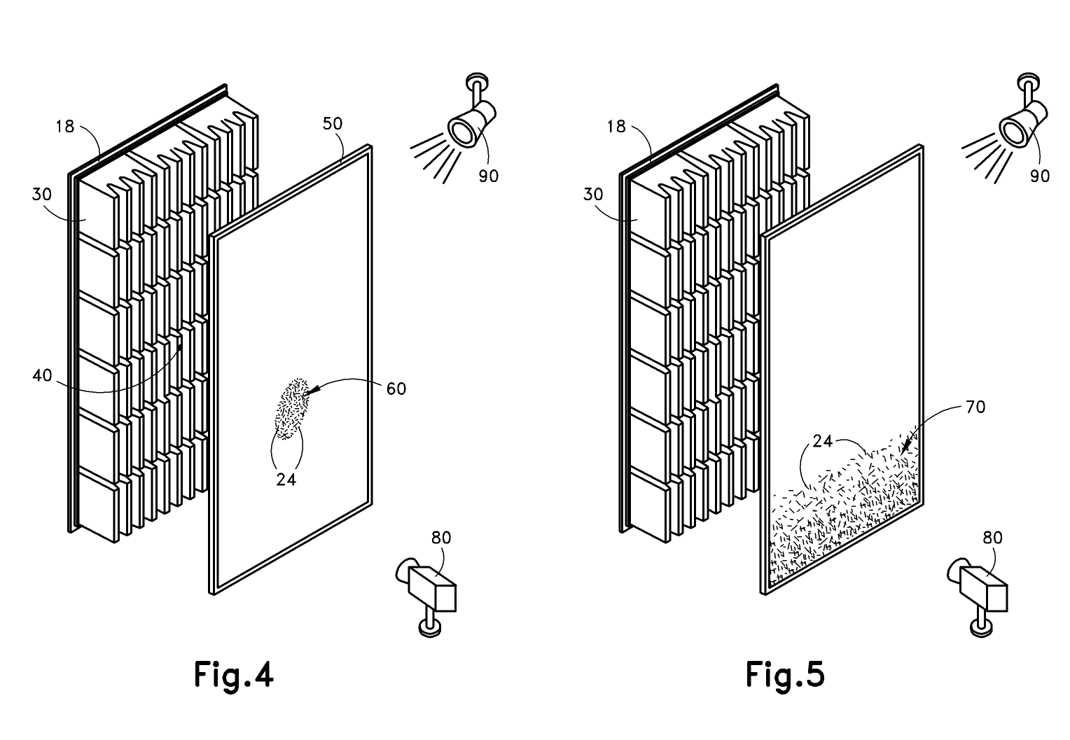

FIG. 4 shows an example of a material (e.g., dust) spot 60 on the indicator member 50 which resulted from the presence of a defect 40 in the filtration media 30. It should be noted that the shown material spot 60 is present on an otherwise “clean” indicator member 50. It is to be appreciated that such presentation is merely for illustration of the concept. It is also possible for the entire indicator member 50 to have at least some level of material retention, but with the material spot 60 being of greater intensity/density of retained material 24 as compared to the other areas of the indicator member.

The location of the material spot 60 on the indicator member 50 has a correspondence with the defect 40 in the filter element 18. An example of this concept is presented via the trajectory cone of travel 56 within FIG. 1. The correspondence may be a relatively straight line of flight between the filter defect 40 location and the material spot 60 on the indicator member 50. Of course, there may be a different type of correspondence. However, the existence of a correspondence is useful to help identify the presence and location of the filter defect 40.

It is possible that other types of undesirable, inefficient, or similar circumstances can be detected/determined in accordance with other aspects of the present invention. For example, attention is directed to FIG. 5 which shows an indicator member 50 having material 24 primarily collected on a lower portion 70 of the member. This may be indicative of a majority of the fluid flow proceeding through the lower portion 70. Such a condition would suggest that a similar majority of the fluid flow proceeding through only a portion (e.g., a lower portion) of the filter element 18. The locality of reduced filtration is located at an area different from an area through which a majority of the fluid flow proceeds and the locality of reduced filtration causes a difference in contrast on the member 50 in comparison to the area through which a majority of the fluid flow proceeds.

Such a circumstance indicates that the filter element 18 may not be utilized in an efficient manner. With such information provided by an indication upon the indicator member 50, it may be possible to take some corrective efforts to cause the fluid flow to more evenly proceed through the filter element 18.

Turning now to a process of evaluating accumulation of material upon the member, it should be appreciated that various techniques, methods, structures, etc. may be employed. As one example it is to be appreciated that the indicator member 50 may be viewed by an unaided human eye. It is possible the indicator member 50 could be displaced and/or removed for periodic inspection. As another variation, the structure 16 containing the fluid flow could be configured (e.g., use of a clear panel) to permit visual observation while the indicator member 50 is in place and the fluid is flowing (i.e., operational).

As yet another example, a remote viewing arrangement may be utilized. A schematic example of such is shown in each of FIGS. 2-5. Specifically, a camera 80 is provided, with the camera for obtaining an image of the indicator member 50. The image(s) may be stored for later use, comparison, remote viewing, and the like. Associated with the camera is an illumination source (e.g., a light source) 90. Of course, the type, position, number, etc. of the camera 80 and/or illumination source 90 may be varied. Also, the camera 80 and/or illumination source 90 may be related to the type of material 24 to be filtered. For example, if the material is florescent, associated spectral illumination/camera may be utilized.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A system for fluid filtration an for providing and indication of filtration operation, the system including:
a filtration media for permitting flow of fluid there through and for filtering at least one material from the fluid, the filtration media having an upstream side and a downstream side; and
a member located adjacent to the downstream side of the filtration media and permitting flow of the fluid there through, the member retaining at least some of the at least one material not filtered from the fluid by the filtration media, the member being contrast to the at least one material so that an indication of locality of reduced filtration of the at least one material is provided.

2. A system as set forth in claim 1, wherein the indication of locality of reduced filtration is a visual indication.

3. A system as set forth in claim 1, wherein one of the member and the material has a light shade and the other of the member and the material has a dark shade.

4. A system as set forth in claim 1, wherein the contrast between the member and the material is visible to the human eye.

5. A system as set forth in claim 1, further including a camera for obtaining an image of the member.

6. A system as set forth in claim 1, further including an illumination source for illuminating of the member.

7. A system as set forth in claim 1, wherein the locality of reduced filtration indicates a defect within the filtration media.

8. A system as set forth in claim 7, wherein the defect causes a spot of material upon the member.

9. A system as set forth in claim 1, wherein the locality of reduced filtration is located at an area different from an area through which a majority of the fluid flow proceeds.

10. A system as set forth in claim 1, wherein the locality of reduced filtration causes a difference in contrast on the member in comparison to the area through which a majority of the fluid flow proceeds.

11. A system as set forth in claim 1, wherein contrast between the member and the material includes at least one of shade, color, florescence and spectral.

12. A system for fluid filtration utilizing a filtration media that permits flow of fluid there through and that filters at least one material from the fluid such that the filtration media having an upstream side and a downstream side, and the system providing an indication of filtration operation, the system including:
a member located adjacent to the downstream side of the filtration media and permitting flow of the fluid there through, the member retaining at least some of the at least one material not filtered from the fluid by the filtration media, the member being contrast to the at least one material so that an indication of locality of reduced filtration of the at least one material is provided.

13. A system as set forth in claim 12, wherein the indication of locality of reduced filtration is a visual indication.

14. A system as set forth in claim 12, wherein one of the member and the material has a light shade and the other of the member and the material has a dark shade.

15. A system as set forth in claim 12, wherein the contrast between the member and the material is visible to the human eye.

16. A system as set forth in claim 12, further including a camera for obtaining an image of the member.

17. A system as set forth in claim 12, further including an illumination source for illuminating of the member.

18. A system as set forth in claim 12, wherein the locality of reduced filtration is located at an area different from an area through which a majority of the fluid flow proceeds.

19. A system as set forth in claim 12, wherein the locality of reduced filtration causes a difference in contrast on the member in comparison to the area through which a majority of the fluid flow proceeds.

20. A system as set forth in claim 12, wherein contrast between the member and the material includes at least one of shade, color, florescence and spectral.
